(19) United States
(12) Patent Application Publication
(10) Pub. No.: US 2018/0108075 A1
(43) Pub. Date: Apr. 19, 2018

(54) Systems and Methods of Order Fulfillment

(71) Applicant: Michael Willett, Dacula, GA (US)

(72) Inventor: Michael Willett, Dacula, GA (US)

(21) Appl. No.: 15/784,081

(22) Filed: Oct. 13, 2017

Related U.S. Application Data
(60) Provisional application No. 62/407,933, filed on Oct. 13, 2016.

(51) Int. Cl. G06Q 30/06; G06Q 10/08

(52) U.S. Cl. CPC G06Q 30/0635; G06Q 10/087

(57) ABSTRACT

Example embodiments of the systems and methods of order fulfillment provided herein receive an order from a potential customer and provide automatic fulfillment by one or more of multiple suppliers, based on one or more factors, the factors including at least one of distance, product availability, pricing, equipment age, and percentage of order fulfillment capability. In an example embodiment, one or more databases will be maintained, or one or more tables within a database. One database/table is for the consumer, one database/table for the enablement processing, which may be referred to as a call center (though no actual calls may take place), and a third vendor database/table.

### CROSS-REFERENCE TO RELATED APPLICATION

This application claims benefit to U.S. provisional patent application Ser. No. 62/407,933, filed on Oct. 13, 2016, which is incorporated by reference herein.

### TECHNICAL FIELD

The present disclosure is generally related to electronic orders and, more particularly, is related to automated order fulfillment between vendors and consumers.

### BACKGROUND

With special effects equipment and many other products, there is difficulty in the market in connecting a potential buyer/renter/customer with a vendor that has the desired product available. There are heretofore unaddressed needs with previous solutions.

### SUMMARY

Example embodiments of the present disclosure provide systems of order fulfillment. Briefly described, in architecture, one example embodiment of the system, among others, can be implemented as follows: a customer portal configured to receive order information from a customer, the order information comprising equipment information, delivery date, duration, and location; a vendor portal configured to receive equipment information from a vendor and store the vendor equipment information in a vendor equipment database; and a fulfillment module configured to match customer order information with the vendor equipment information in the vendor equipment database and place an order with a vendor for equipment according to the matching.

Embodiments of the present disclosure can also be viewed as providing methods for order fulfillment. In this regard, one embodiment of such a method, among others, can be broadly summarized by the following steps: receiving equipment information from a vendor; storing vendor equipment information in a vendor equipment database; receiving order information from a customer, the order information comprising equipment information, delivery date, duration, and location; matching customer order information with the vendor equipment information in the vendor equipment database; and placing order with vendor for equipment according to the matching.

### BRIEF DESCRIPTION OF THE DRAWINGS

FIG. 1 is a block diagram of an example embodiment of a system for order fulfillment.

FIG. 2 is a flow diagram of an example embodiment of a method of order fulfillment.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

Example embodiments of the systems and methods of order fulfillment provided herein receive an order from a potential customer and provide automatic fulfillment by one or more of multiple suppliers, based on one or more factors, the factors including at least one of distance, product availability, pricing, equipment age, and percentage of order fulfillment capability. In an example embodiment, one or more databases will be maintained, or one or more tables within a database. At least one database/table is for the consumer, at least one database/table for the enablement processing, which may be referred to as a call center (though no actual calls may take place), and at least a third vendor database/table.

A customer, at the last minute, needs to find some special effects equipment, such as, as non-limiting examples, CO2 tanks, confetti cannons, paint cannons, bubble machines, smoke machines, and t-shirt cannons, among others, for a party. The customer can use an example embodiment of the systems and methods of order fulfillment disclosed herein to fulfill their order. Although, the order fulfillment system is described in terms of a special effects equipment order, it would be applicable to any product or service. An example embodiment includes a portal on the front end for the user and a portal on the back end for the vendor. In the middle, is the call center or fulfillment module, which may be, for example a computer program with an algorithm to match the requests with the available vendor equipment. In an example implementation, the consumer accesses a computer application, for example on her phone, and enter an order for twenty fog machines for an event at noon tomorrow. The fulfillment module matches vendors with available equipment to the customer request.

First the consumer signs up with the system, for example, by inputting their personal/business info, credit card info, etc. The customer then enters order information, for example, twenty fog machines. Currently, the customer would have to call around to find various event companies or party rental companies to try to get access twenty fog machines. Example embodiments of the systems and methods disclosed herein facilitate that access.

In an example embodiment, the algorithm searches the available equipment saved in the vendor database by, in an example embodiment, proximity first because the goal may be to get the equipment that the customer needs in the fastest, most efficient way possible. In one example embodiment, the customer can configure the algorithm such that anyone within a particular radius, for example, is considered to be the same distance and the order is fulfilled based on price, or on whether the vendor can fulfill the entire order.

In an example embodiment, a bidding option is implemented such that if the algorithm finds Vendor A and Vendor A is within 5 miles and Vendor A has 5 fog machines, then the next vendor is Vendor B and he has 10, and the next is vendor is Vendor C and he has 5. The fulfillment module may fulfill the order by proximity. For example, one vendor may be 5 miles away, one may be 12 miles away, one may be 16 miles away and one may be 100 miles away, all having some stock in the requested equipment. In an example embodiment, the fulfillment module allows the vendors to verify availability and enter a bid to secure the lowest price for the customer. The vendor may then confirm the info. Within a preset time duration, using the current bids (or previously submitted pricing if a new lowest pricing wasn't submitted) the order may be confirmed and the credit card of the consumer may be charged. In an example embodiment, the consumer may docu-sign the rental paperwork and the order is fulfilled.

In an example embodiment, any vendor equipment included in the vendor equipment database/table is identified with a barcode. When the equipment is available for use from the vendor, the vendor scans the bar code and the vendor database/table is updated. When the equipment leaves the vendor, the vendor scans the bar code so that the system knows that it is already in use and not available for another customer. Vendors may use this function for inventory management. Reminders may be set when a piece of equipment is out for longer than a predetermined time period.

In an example embodiment, when a consumer accesses the order fulfillment system and requests equipment, a vendor is not notified of the equipment request if that vendor has already scanned those machines as in use. The vendor is only notified of a pending request if the equipment (with the barcode) has been scanned in as readily available. Some vendors may have large volumes of unused equipment sitting on the shelves. If the vendor could rent them for $20 a day, at a discount from regular pricing of $50 a day, the vendor would likely rather be making $20 a day than not making anything on them. Example embodiments of the disclosed systems and methods help vendors with extra inventory that would not necessarily be used because for example, maybe it is not peak season or maybe the vendor is not well-known enough for people to even find him.

In an example embodiment, an emergency option is available. For example, if an event is scheduled to begin in two hours and a piece of equipment has broken or is misplaced, for example, the emergency option would only search by proximity. The emergency option would search by proximity first, no matter what condition the equipment is in or how much it costs.

In an example embodiment, a courier is automatically selected by the system and a price is configured and agreed upon to deliver the equipment to the customer. The shipping costs may be charged through the system. In an example implementation, a customer submits an order. The disclosed system determines which vendor has the equipment, can fulfill it with the lowest price, and deliver by a particular time. The system may notify the vendor and obtain a confirmation from the vendor. The customer pays and signs the rental agreement through the disclosed system. Then the disclosed system may schedule one or more couriers to pick up the equipment from the appropriate location(s) and deliver to the customer before the predetermined time.

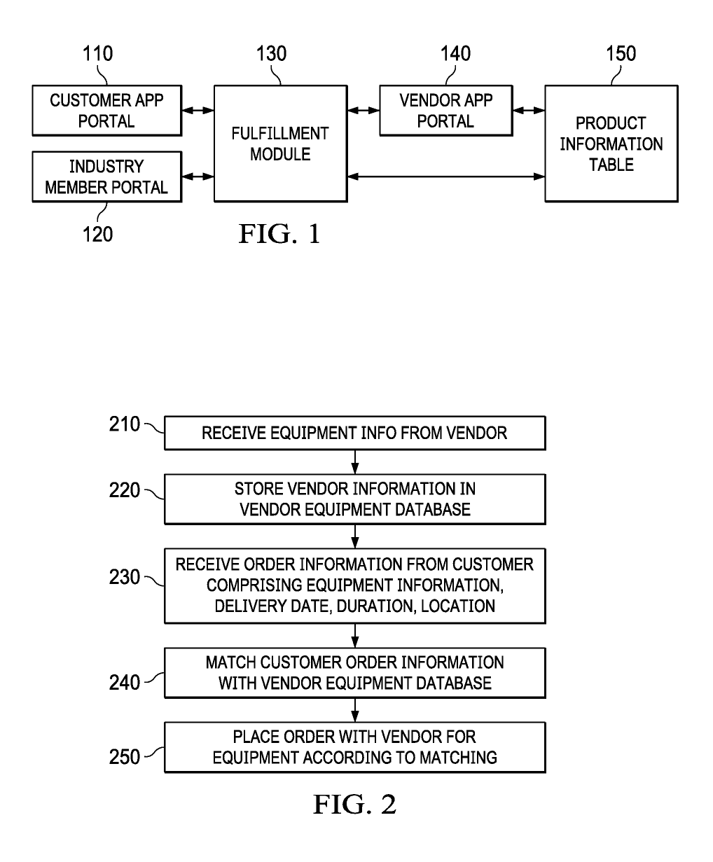

FIG. 1 provides a system diagram of an example embodiment of a system of order fulfillment disclosed herein. The system may comprise customer portal app 110, industry member portal 120, fulfillment module 130, vendor app portal 140 and product database/table 150. A customer using customer app portal 110 sends a request for equipment to fulfillment module 130. The customer may sign up with the system by registering her contact info and credit card information through customer app portal 110. The customer may request equipment based on the date, equipment category, load-in time, load-out time, return date, equipment age, price, and fulfillment distance as non-limiting examples. Customer app portal 110 may comprise an emergency button that would set a priority on distance so that the equipment could be delivered as soon as possible.

Industry member portal 120 has similar capabilities as customer app portal 110, but optimized for production managers, for example, that wish to utilize the service for a discount by paying a monthly subscription.

In an example embodiment, fulfillment module 130 is an algorithm stored in memory and run on a processor with the function of fulfilling an equipment request from a customer with equipment that best fits the customer requirements based on the parameters set by the customer in customer app portal 110. Fulfillment module 130 may receive equipment requests and searches product info table 150 to match the customer equipment request with available equipment from product info table 150. The algorithm may match the equipment to the request based on several factors including, but not limited to, proximity, availability, equipment condition, pricing, and others. These factors may be preset as priority defaults and/or they may be configurable by the customer in the request. Fulfillment module 130 may send a message to the customer through customer app portal 110 to alert the customer that the fulfillment request is being processed. An alert may also be sent when the fulfillment is confirmed. In an alternative embodiment, fulfillment module 130 may assign an account manager for follow up based on the region in which the order is filled. Fulfillment module 130 may also comprise a monetary transaction module for processing the credit card. Fulfillment module 130 may send the customer a link for a rental agreement with terms and conditions.

In an example embodiment, equipment vendors input company information into vendor app portal 140. Vendor may also input product/equipment info through vendor app portal 140. In an example embodiment, the product list may be imported from an inventory list. The vendor may receive notification through vendor app portal 140 that a match was made between a customer request and the vendor inventory from product info table 150. The vendor may accept a fulfillment through vendor app portal 140 by clicking a confirmation button and agreeing to the terms and conditions that the customer agreed to. Vendor app portal 140 may also interface with a bar code scanner to scan all equipment available for order fulfillment. Product info table 150 may be updated based on the bar code scans. If equipment has been scanned as returned, then it is available for fulfillment by the system. In an example embodiment, equipment may also include certified on-site technicians, setup technicians, operators, riggers, and such.

FIG. 2 provides an example embodiment of a method of order fulfillment. In block 210, equipment information is received from a vendor. In block 220, the vendor equipment information is stored in a vendor equipment database. In block 230, order information is received from a customer. The order information may include as non-limiting examples delivery date, duration, and location. In block 240, the customer order information is matched with the vendor equipment database. In block 250, an order is placed with the vendor for equipment according to the matching.

The flow chart of FIG. 2 shows the architecture, functionality, and operation of a possible implementation of the order fulfillment software. In this regard, each block represents a module, segment, or portion of code, which comprises one or more executable instructions for implementing the specified logical function(s). It should also be noted that in some alternative implementations, the functions noted in the blocks may occur out of the order noted in FIG. 2. For example, two blocks shown in succession in FIG. 2 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

Although the present disclosure has been described in detail, it should be understood that various changes, substitutions and alterations can be made thereto without departing from the spirit and scope of the disclosure as defined by the appended claims.

Therefore, at least the following is claimed:

1. A method comprising:
receiving equipment information from a vendor;
storing vendor equipment information in a vendor equipment database;
receiving order information from a customer, the order information comprising equipment information, delivery date, duration, and location;
matching customer order information with the vendor equipment information in the vendor equipment database; and
placing order with vendor for equipment according to the matching.

2. The method of claim 1, further comprising receiving fulfillment priority parameters from the customer.

3. The method of claim 2, wherein the fulfillment priority parameters comprise at least one of proximity, availability, equipment condition, and pricing.

4. The method of claim 2, wherein matching customer order information is performed based on the fulfillment priority parameters from the customer.

5. The method of claim 1, further comprising confirming that a vendor has equipment available.

6. The method of claim 1, further comprising receiving a request for delivery and scheduling a courier.

7. The method of claim 1, further comprising removing equipment from the vendor equipment database after order is placed

8. The method of claim 7, further comprising reloading the equipment into the vendor equipment database when equipment is returned.

9. An order fulfillment system comprising:
a customer portal configured to receive order information from a customer, the order information comprising equipment information, delivery date, duration, and location;
a vendor portal configured to receive equipment information from a vendor and store the vendor equipment information in a vendor equipment database; and
a fulfillment module configured to match customer order information with the vendor equipment information in the vendor equipment database and place an order with a vendor for equipment according to the matching.

10. The system of claim 9, wherein the customer portal is further configured to receive fulfillment priority parameters from the customer.

11. The system of claim 10, wherein the fulfillment priority parameters comprise at least one of proximity, availability, equipment condition, and pricing.

12. The system of claim 9, the fulfillment module is further configured to match customer order information based on the fulfillment priority parameters of the customer.

13. The system of claim 9, wherein the fulfillment module is further configured to confirm that a vendor has equipment available.

14. The system of claim 9, wherein the customer portal is further configured to receive a request for delivery and the fulfillment module is further configured to schedule a courier.

15. A computer readable medium comprising software for order fulfillment, the software comprising instructions for:
receiving equipment information from a vendor;
storing vendor equipment information in a vendor equipment database;
receiving order information from a customer, the order information comprising equipment information, delivery date, duration, and location;
matching customer order information with the vendor equipment information in the vendor equipment database; and
placing order with vendor for equipment according to the matching.

16. The computer readable medium of claim 15, further comprising instructions for receiving fulfillment priority parameters from the customer.

17. The computer readable medium of claim 16, wherein the fulfillment priority parameters comprise at least one of proximity, availability, equipment condition, and pricing.

18. The computer readable medium of claim 16, wherein instructions for matching customer order information are performed based on the fulfillment priority parameters from the customer.

19. The computer readable medium of claim 15, further comprising instructions for confirming that a vendor has equipment available.

20. The computer readable medium of claim 15, further comprising instructions for receiving a request for delivery and scheduling a courier.
